(19) United States
(12) Patent Application Publication
(10) Pub. No.: US 2007/0295461 A1
(43) Pub. Date: Dec. 27, 2007

(54) Curved Brace Edge Connection Fitting of Window

(76) Inventor: Jung Ryoul Kim, Seoul (KR)

Correspondence Address: LADAS & PARRY LLP, 224 SOUTH MICHIGAN AVENUE, SUITE 1600, CHICAGO, IL, 60604, US

(21) Appl. No.: 11/573,805

(22) PCT Filed: Aug. 30, 2005
(86) PCT No.: PCT/KR05/02867

§ 371 Date: Feb. 16, 2007

(30) Foreign Application Priority Data
Aug. 31, 2004 (KR) 20-2004-0024860

(51) Int. Cl. E06B 3/96

(52) U.S. Cl. 160/381

(57) ABSTRACT

A curved brace edge connection fitting and a curved brace paired window edge connection fitting and a window structure are provided. A coupling intensity of existing modular edge connection fittings can be heightened to simultaneously enhance air-tightness and heat insulation and to further provide effects of curved design and easy cleaning. The curved brace window frame edge connection fitting and the curved brace paired window edge connection fitting are used in a push-to-open window called a slider and a rotate-to-open window called a casement.

### TECHNICAL FIELD

The present invention relates to a modular edge connection fitting which is used for a modular window frame and window pair and a window structure using the same, and more particularly to, a curved brace edge connection fitting and a curved brace paired window edge connection fitting corresponding to the curved brace edge connection fitting and a window structure using the same, to thereby enhance a coupling intensity of existing modular edge connection fittings to simultaneously enhance air-tightness and heat insulation and to thus provide effects of curved design and easy cleaning.

### BACKGROUND ART

An existing window frame edge connection fitting which is widely used is shown in FIG. 1.

FIG. 1 shows part of an edge portion at one side of a window frame. For convenience of understanding, a horizontal bar 2 and a vertical bar 3 which are somewhat complicated are simply represented in sectional shape. Protrusions 10 are inserted into the horizontal bar 2 and the vertical bar 3, respectively, in order to firmly couple an edge connection fitting with the horizontal bar 2 and the vertical bar 3, when the edge connection fitting is fitted with the horizontal bar 2 and the vertical bar 3. A rubber packing 12 is interposed between each of the horizontal bar 2 and the vertical bar 3 and the edge connection fitting 5, in order to enhance air-tightness, respectively. On the upper portion of the horizontal bar 2 are formed a raised step 6, a groove 13 and a packing insertion groove (not shown) in lengthy direction. Likewise, on the upper portion of the vertical bar 3 are formed a raised step 6, a groove 13 and a packing insertion groove (not shown) in lengthy direction. In assembly, a worker fits the cut end portions of the horizontal bar 2 and the vertical bar 3 with the edge connection fitting 5 and then makes holes such as piece holes or screw holes into the edge connection fitting 5 by using a drilling machine, to then tighten pieces or screws 8 into the piece holes or screw holes. In FIG. 1, a reference numeral 7 denotes a piece hole or screw hole.

FIG. 2 shows a coupled state of FIG. 1, in which the horizontal bar 2 and the vertical bar 3 are coupled with the edge connection fitting 5 according to the conventional art. A window frame is classified into a convex type and a concave type according to the shape of the window frame with which a paired window is fitted. FIG. 2 shows a convex type window frame. A paired window is slid on the raised step 6. A concave type window frame is fabricated in the same shape and fabrication method as that of the convex type window frame, although it is not shown in the drawings. FIG. 2 shows positions of the raised step 6, the groove 13, and the screw hole 7.

FIG. 3 is a perspective view showing a coupling relationship of a conventional paired window edge connection fitting 5a. A glass groove 17a is formed in the inner circumference of the paired window edge connection fitting 5a, and a packing insertion groove 11a is formed in the lower portion of the glass groove 17a. The paired window edge connection fitting 5a is coupled in the same pattern as that of the window frame edge connection fitting 5. That is, protrusion 10a of the paired window edge connection fitting 5a are fitted into a horizontal bar 2a and a vertical bar 3a, respectively, and tightened by screws 8a to then be assembled with the horizontal bar 2a and the vertical bar 3a.

In FIGS. 2 and 3, the window frame edge connection fitting 5 and the paired window edge connection fitting 5a provide a coupling function which fits horizontal bars 2 and 2a and vertical bars 3 and 3a, respectively. Since the edge connection fittings 5 and 5a where the horizontal bars 2 and 2a and vertical bars 3 and 3a are crossed are coupled perpendicularly, the coupled modular window frame is weak with respect to a diagonally lateral compression force. Thus, in the case of windows at the windy seaside areas, high buildings, or seismal places, stronger connection fittings are required.

Also, the window frame edge connection fitting 5 and the paired window edge connection fitting 5a have no proper structures of packing insertion grooves 11a of FIGS. 2 and 3 into which packing members such as mohair called wind-proof hair (not shown) and gaskets made of soft rubber can be inserted.

That is, the horizontal bars 2 and 2a and vertical bars 3 and 3a are crossed are coupled perpendicularly, at the edge connection fittings 5 and 5a. Accordingly, packing members cannot be inserted into packing insertion grooves. Thus, the packing members are cut and used according to the lengths of the horizontal bars 2 and 2a, respectively. In the case of the vertical bars 3 and 3a, the packing members are also cut and used according to the lengths thereof. The packing members such as mohair called wind-proof hair (not shown) and gaskets made of soft rubber which are inserted into the horizontal bars 2 and 2a and vertical bars 3 and 3a are cut and used in proper lengths according to a skillfulness of a worker who performs a window assembly, and are fitted into the packing insertion grooves 11a. No matter how a worker is skill, he or she cuts packing members such as mohair called wind-proof hair (not shown) and gaskets made of soft rubber by eye measure in order to heighten a working speed, when the packing members are fitted into the packing insertion grooves 11a formed in the horizontal bars 2 and 2a and vertical bars 3 and 3a. As a result, the packing members may be cut shortly in comparison with the lengths of the horizontal bars 2 and 2a and vertical bars 3 and 3a, and thus it is difficult to insert the packing members such as mohair called wind-proof hair (not shown) and gaskets made of soft rubber which have been cut in proper lengths into the packing insertion grooves 11a formed in the horizontal bars 2 and 2a and vertical bars 3 and 3a. The packing members having been inserted into the packing insertion grooves formed in the horizontal bars 2 and 2a and vertical bars 3 and 3a reduce heat insulation and air-tightness, to thereby lower an energy efficiency and generate noise. Also, it is not so easy to clean dust collected in the perpendicular edges.

FIG. 13 is a perspective view of a typical casement which is one of casements. FIG. 14 is a perspective view of a tilt which is one of casements. FIG. 15 is a lateral cross-sectional view of a project which is one of casements. An edge connection fitting for a modular casement is not much developed in comparison with that of a slider. However, in the case of a slider which is opened in the form of protruding inwards or outwards in view of structure of a window, edge portions of a paired window 1a have a sharp point, respectively. This, if an article or person collides with the pointed edges due to carelessness, the article may be broken or the head or face of the person may be damaged severely. The protruded edge portions of synthetic resin window, wooden window, and hybrid window are always dangerous. In particular, since the edge portions of an aluminum window are sharp like a knife blade, an article or the head or face of person colliding with the pointed edges due to carelessness may be broken or damaged severely. Such an accident frequently takes place.

### DISCLOSURE OF THE INVENTION

To solve the above problems, it is an object of the present invention to provide a curved brace window frame edge connection fitting which enhances a coupling intensity in which a brace playing a role of a brace in the window is formed as a window frame edge connection fitting located in an angular edge of the window frame in a window structure which is installed in an angular opening portion and employing a modular window frame.

It is another object of the present invention to provide a curved brace paired window edge connection fitting corresponding to a curved brace window frame edge connection fitting, which enhances a coupling intensity between the curved brace paired edge connection fitting and a curved brace window frame edge connection fitting, and which provides effects of air-tightness, heat insulation, soundproofing, safety from collision during opening and closing, and easy cleaning in which a packing insertion groove is curvedly formed along the curved paired window edge connection fitting and a packing member is inserted into the packing insertion groove.

It is still another object of the present invention to provide a window structure employing a curved brace window frame edge connection fitting and/or a curved brace paired window edge connection fitting.

It is a further object of the present invention to provide a window structure including glass, in which glass is directly fitted into a window frame edge connection fitting or paired window edge connection fitting.

To accomplish the above object of the present invention, according to an aspect of the present invention, there is provided a curved brace window frame edge connection fitting for use in a window structure which is installed in an angular opening portion of an architecture building and is formed of a modular window frame, in which the window frame edge connection fitting is positioned at the angular edge of the window frame, characterized in that the window frame edge connection fitting comprises a brace formed in an edge on the inner circumference of the window frame edge connection fitting, wherein the brace is curved, and the outer circumference of the window frame edge connection fitting is angularly formed so as to be congruous with the angular edge of the angular opening portion.

Also, there is provided a curved brace paired window edge connection fitting for use in a window structure which is installed in an angular opening portion of an architecture building and is formed of a modular set of a window frame and a paired window coupled with the window frame, in which the paired window edge connection fitting is positioned at the edge of the paired window, characterized in that the paired window edge connection fitting is curved so that the outer circumference of the paired window edge connection fitting is congruous with the inner circumference of a curved brace in a window frame edge connection fitting in correspondence to the curved brace window frame edge connection fitting of claim 1, and a curved packing insertion groove is formed on the outer circumference of the paired window edge connection fitting.

Also, there is provided a window structure which is installed in an angular opening portion of an architecture building, the window structure comprising: a modular window frame including a curved brace edge connection fitting of claim 1; and glass which is fitted into the window frame, wherein the glass is fitted in a glass groove formed in the inner circumference of the window frame including the curved brace window frame edge connection fitting, and the glass groove formed in the inner circumference of the window frame including the curved brace window frame edge connection fitting is angularly formed along an angle formed by the outer circumference of the window frame edge connection fitting.

Also, there is provided a window structure which is installed in an angular opening portion of an architecture building, the window structure comprising: a modular window frame including a curved brace edge connection fitting of claim 1; and a modular paired window which is coupled with the window frame to allow an angular opening portion to be opened and closed, including a curved brace paired window edge connection fitting of claim 2, wherein a packing insertion groove of the curved paired window edge connection fitting is successively extended and formed on the outer circumference of the paired window.

Here, the window structure is a glass window structure including glass fitted into the paired window, the inner circumference of the curved brace paired window edge connection fitting in the paired window is formed of a curved plane of the same curvature as that of the outer circumference thereof, and the glass is fitted in a glass groove formed in the inner circumference of the paired window including the curved brace paired window edge connection fitting, and the glass groove formed in the inner circumference of the paired window including the curved brace paired window edge connection fitting is angularly formed along an angle formed by the outer circumference of the curved brace paired window edge connection fitting.

### BRIEF DESCRIPTION OF THE DRAWINGS

The above and other objects and advantages of the present invention will become more apparent by describing the preferred embodiment thereof in detail with reference to the accompanying drawings in which:

FIG. 1 is a front view showing a coupling relationship of only part of an edge portion in a conventional window frame edge connection fitting;

FIG. 2 is a perspective view of the coupled edge portion of FIG. 1;

FIG. 3 is a perspective view showing a conventional paired window edge connection fitting;

FIG. 4 is a perspective view showing part of a curved brace window frame edge connection fitting which is used for a slider according to an embodiment of the present invention;

FIG. 5 is a cross-sectional view showing a curved brace window frame edge connection fitting which is used for a slider according to an embodiment of the present invention;

FIG. 6 is a perspective view showing a coupling relationship of part of a curved brace paired window edge connection fitting which is used for a slider according to an embodiment of the present invention;

FIG. 7 is a perspective view showing a curved brace paired window edge connection fitting, a horizontal bar, and a curved brace window frame edge connection fitting, which are used for a slider according to an embodiment of the present invention;

FIG. 8 is a perspective view showing part of a curved brace window frame edge connection fitting which is used for a casement according to an embodiment of the present invention;

FIG. 9 is a perspective view showing a coupling relationship of part of a curved brace paired window edge connection fitting which is used for a casement according to an embodiment of the present invention, which is viewed from the front side;

FIG. 10 is a perspective view showing a coupling relationship of part of a curved brace paired window edge connection fitting which is used for a casement according to an embodiment of the present invention, which is viewed from the rear side;

FIG. 11 is a front view of a slider;

FIG. 12 is a front view of a single-hung;

FIG. 13 is a perspective view of a casement which is one of casements;

FIG. 14 is a perspective view of a tilt which is one of casements;

FIG. 15 is a lateral cross-sectional view of a project which is one of casements; and

FIG. 16 is a perspective view of a fixed according to another embodiment of the present invention.

### BEST MODE FOR CARRYING OUT THE INVENTION

Hereinbelow, a curved brace edge connection fitting and a window structure using the same according to the present invention will be described with reference to the accompanying drawings.

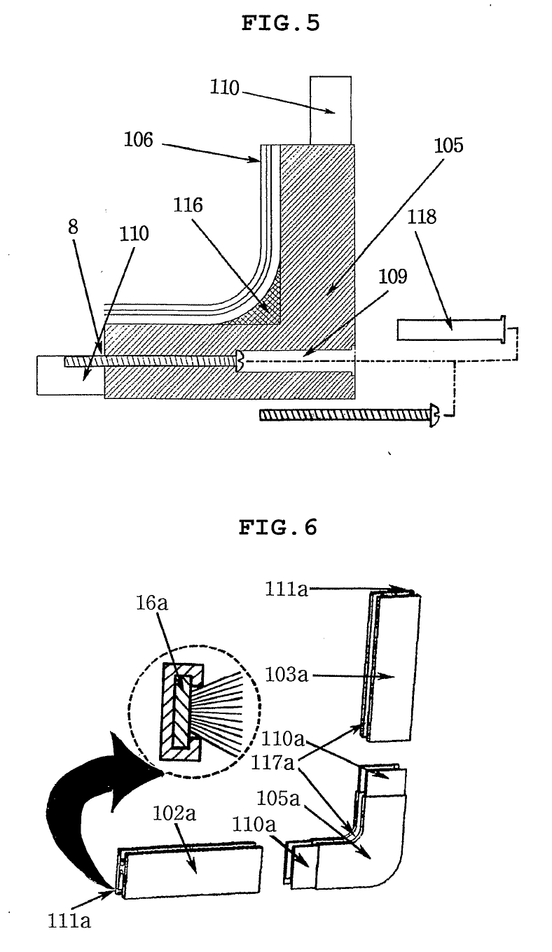

FIG. 4 is a perspective view showing a coupling relationship of a curved brace window frame edge connection fitting which is used for a slider according to an embodiment of the present invention. FIG. 5 is a laterally cross-sectional view showing a curved brace window frame edge connection fitting which is used for a slider according to an embodiment of the present invention.

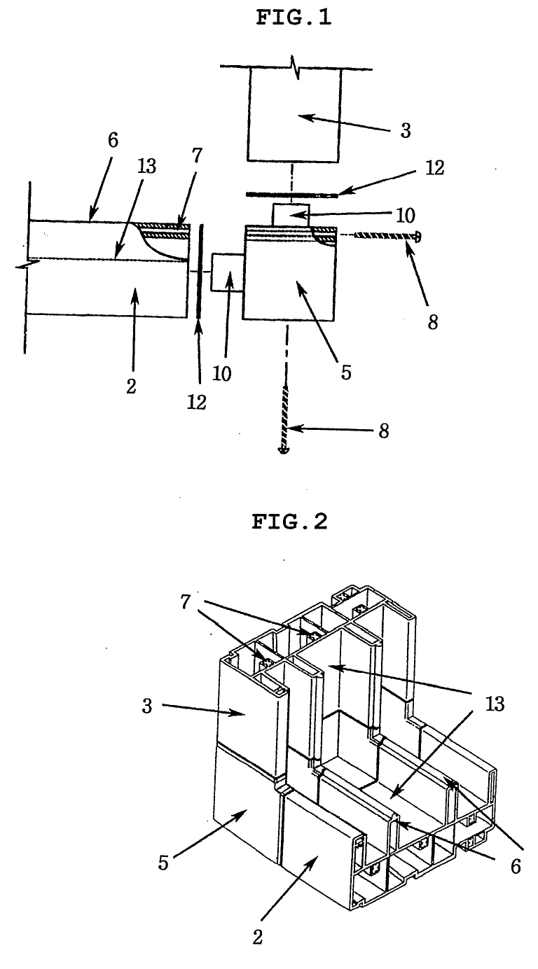

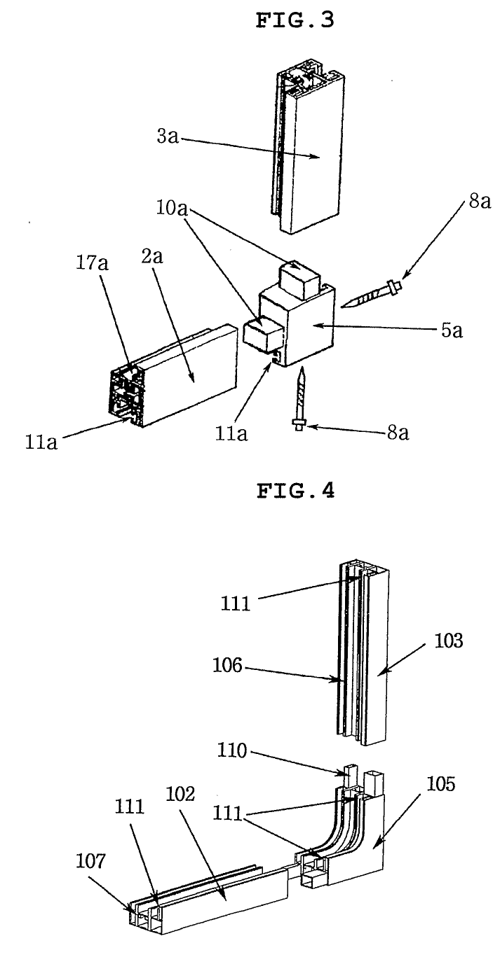

Referring to FIGS. 4 and 5, a brace 116 which does not exist in the conventional window frame edge connection fitting 5 of FIG. 1 is formed in a curved brace window frame edge connection fitting 105. The brace 116 plays a role of preventing distortion and contortion of the window frame so that the frame is not deformed due to a compression force or tension applied to the window frame structure, and uniformly dispersing wind, pressure and vibration applied to the window frame structure to a horizontal bar 102 and a vertical bar 103, as well.

A portion playing a role of the brace 116 can be formed as a linear portion of a triangle. However, the brace 116 can be preferably curved as shown in FIG. 5. If the brace 116 is curved, additional effects such as a design effect of esthetic appreciation, an easy cleaning, and safety due to a curved surface can be obtained.

The inner circumference of the curved brace window frame edge connection fitting 105 has a structure that a raised step 106, a groove (not shown), and a packing insertion groove 111 having the same shapes as those of the raised step 106, the groove (not shown), and the packing insertion groove 111 formed in each of the horizontal bar 102 and the vertical bar 103 are curved. The edge portion in the conventional art is formed perpendicularly, to thus cause a difficult cleaning. However, since the inner circumference of the curved brace window frame structure edge connection fitting 105 is curved, an effect of an easy cleaning can be obtained. Also, a packing member (not shown) such as mohair of wind-proof hair and gasket of soft rubber is inserted into the packing insertion groove 111 at a time without cutting the packing member, and possibly fitted by turning, to thereby enhance heat insulation, air-tightness, and soundproof.

The outer circumference of the curved brace window frame edge connection fitting 105 is planar and perpendicular and differs from the inner circumference thereof of the curved shape. The reason why the outer circumference of the curved brace window frame edge connection fitting 105 is due to the fact that an opening portion of an architecture building where a window is installed is formed of a rectangular or square shape. That is, for a working convenience, only the inner circumference of the window frame edge connection fitting is curved.

In FIG. 5, a curved brace 116 is formed in the curved brace window frame edge connection fitting 105, and a screw 8 engaged with the horizontal bar 102 passes through a screw hole 109 of the curved brace window frame edge connection fitting 105 and protrudes. Likewise, although it is not shown in FIG. 5, a screw engaged with the vertical bar 103 passes through a screw hole of the curved brace window frame edge connection fitting 105 and protrudes in the case of a vertical axis (not shown). In coupling, protrusions 110 are inserted into the horizontal bar 102 and the vertical bar 103, and then screws 8 having passed through the screw holes 109 are assembled into screw grooves 107 formed in the horizontal bar 102 and the vertical bar 103. This is the same as that of the conventional art. As the length of the edge connection fitting gets longer, the screws 8 have been engaged into the screw grooves 107, and then part of the space in the screw holes 109 can be filled with a cover 118 made of the same material as that of the fabricated window frame.

FIG. 6 is a perspective view showing a coupling relationship of part of a curved brace paired window edge connection fitting 105a which is used for a slider according to an embodiment of the present invention.

A raised step 106a on the inner circumference of the curved brace paired window edge connection fitting 105a is curved. In particular, a glass groove 117a into which glass is fitted is perpendicularly formed so that glass can be conveniently cut. If a curved glass groove is extended up to the portion of the glass groove 117a of the curved brace paired window edge connection fitting 105a, glass is curvedly cut. Thus, a working time is delayed and a manpower cost increases. Accordingly, the glass groove is perpendicularly formed so that glass can be swiftly cut and inserted into the glass groove.

The outer circumference of the curved brace paired edge connection fitting 105a is formed of a curved plane corresponding to the curved brace window frame edge connection fitting. Screw holes (not shown) are formed as in the curved brace window frame edge connection fitting. Here, protrusions 110a are fitted into the horizontal bar 102a and the vertical bar 103a, and then are assembled with screws. This is the same as that of the conventional art. Also, packing insertion grooves 111a formed in the horizontal bar 102a and the vertical bar 103a are formed in a curved structure on the outer circumference of the curved brace paired edge connection fitting 105a. Accordingly, a paired window can be fitted while turning without cutting the packing members such as mohair 16a called wind-proof hair (not shown) and gaskets made of soft rubber. As a result, a working time can be shortened and heat insulation, air-tightness, and soundproofing can be enhanced. The protrusions 110a protrude from the contact surfaces of the paired edge connection fitting 105a, and are formed in structures appropriate for sliders, respectively. That is, the protrusions 110a are inserted into the horizontal bar 102a and the vertical bar 103a, in order to make the horizontal bar 102a and the vertical bar 103a firmly coupled with the edge connection fitting 105a.

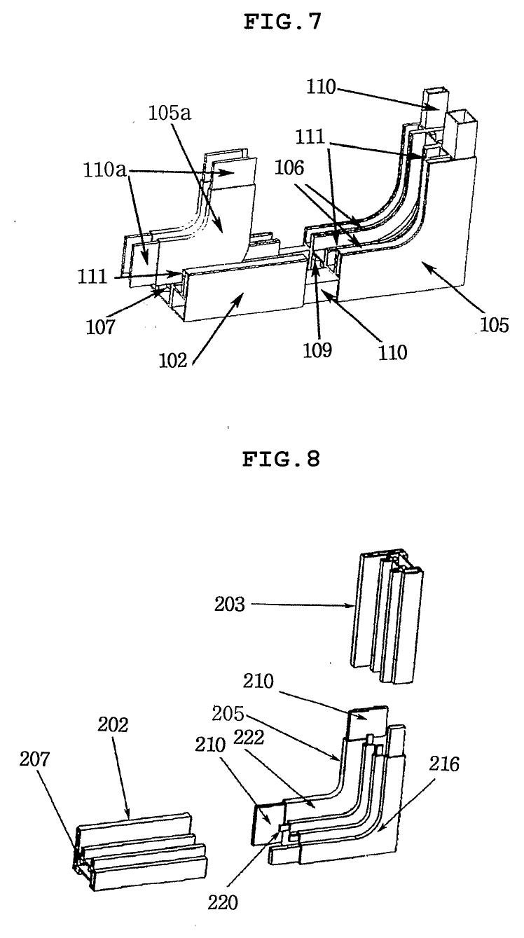

FIG. 7 is a perspective view showing a curved brace paired window edge connection fitting, a horizontal bar, and a curved brace window frame edge connection fitting, which are used for a slider according to an embodiment of the present invention. In FIG. 7, it can be seen that the curved brace paired window edge connection fitting 105a slidingly moves through the horizontal bar 102 and a raised step 106 of the curved brace window frame edge connection fitting 105. Wheels (not shown) smoothing a sliding operation can be mounted on the outer circumference of the paired edge connection fitting. In FIG. 7, the same reference numerals as those of FIGS. 4 and 6 denote the same elements as those of FIGS. 4 and 6.

FIG. 8 is a perspective view showing a coupling relationship of a curved brace window frame edge connection fitting which is used for a casement according to an embodiment of the present invention.

A stopper 222 is formed in a casement but is not formed in a slider. When a paired window is closed, the paired window contacts the stopper 222. That is, the stopper 222 absorbs impact occurring when the paired window is rotated, and is closely involved with heat insulation and air-tightness.

A curved brace 216 is formed in the casement in the same structure as that of the brace 116 used in the slider. The curved brace is a diagonal reinforcement member, which effectively disperses a pressure which is diagonally applied to the curved brace 216, to thus structurally stabilize the window frame of the casement.

The curved brace window frame edge connection fitting of the casement is curved in the same manner as those formed in the horizontal bar 202 and the vertical bar 203. Protrusions 210 are also formed in the curved brace window frame edge connection fitting 205, to thus firmly couple the horizontal bar 202 and the vertical bar 203, and auxiliary protrusions 220 are also formed therein to thus heighten accuracy of coupling. Since a coupling method of the curved brace window frame edge connection fitting 205 is same as that of the conventional art, the detailed description thereof will be omitted. A reference numeral 207 denotes a screw hole in FIG. 8.

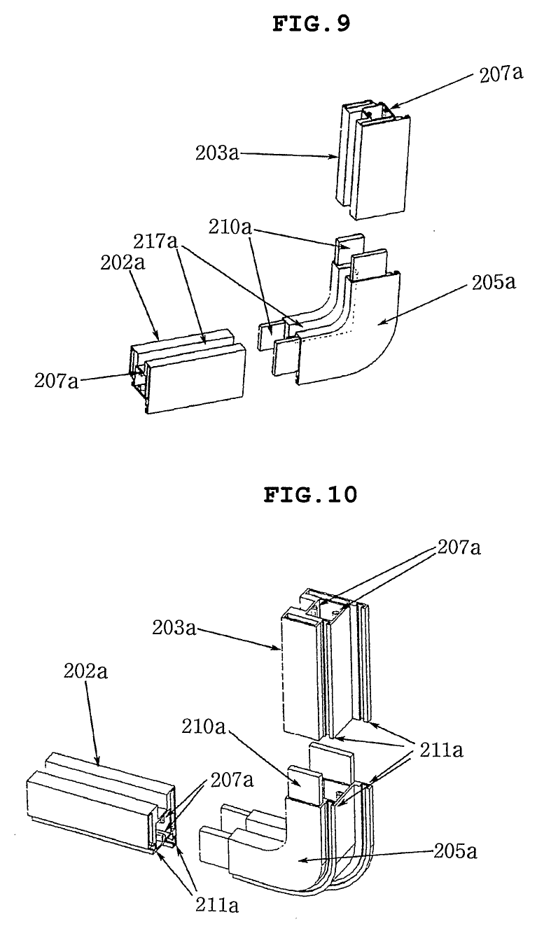

FIG. 9 is a perspective view showing a coupling relationship of part of a curved brace paired window edge connection fitting 205a which is used for a casement according to an embodiment of the present invention, which is viewed from the front side, and FIG. 10 is a perspective view which is viewed from the rear side in FIG. 9.

A raised step 206a on the inner circumference of the curved brace paired window edge connection fitting 205a is curved. In particular, a glass groove 217a into which glass is fitted is perpendicularly formed.

The outer circumference of the curved brace paired edge connection fitting 205a is formed of a curved plane corresponding to the curved brace window frame edge connection fitting 205. That is, the curved brace paired window edge connection fitting 205a should be of a curved structure so as to face the curvature radius of the curved brace window frame structure edge connection fitting 205.

As described above, the outer circumference of the curved brace paired edge connection fitting 205a is formed of a curved plane, and screw holes (not shown) are formed in the outer circumference of the curved brace paired window edge connection fitting 205a, as spaces into which screws are fitted. The screw holes (not shown) are formed in the same manner as that of FIG. 5 which is a cross-sectional view of the window frame edge connection fitting 105. The curved brace paired window structure edge connection fitting 205a has a structure that a raised step 206a, a glass groove (not shown), and a packing insertion groove 114 having the same shapes as those of the raised steps 206a, the glass grooves 217a, and the packing insertion grooves 211a formed in the horizontal bar 202a and the vertical bar 203a are curved. Differently from the paired window of a slider, the curved brace paired window edge connection fitting of a casement bringing a stopper into contact has a structure that packing insertion grooves are formed in one direction and thus the window is rotated by means of a hinge or a hinge arm so as to be opened and closed. The paired window also performs such a rotational function to bring a stopper of a window frame into contact so that the paired window is closed.

Referring to FIG. 10, a packing member (not shown) fitted into the a packing insertion groove of the vertical bar are fitted into packing insertion grooves of the horizontal bar along the packing insertion grooves of the curved edge connection fitting, and then fitted with the curved edge connection fitting again. Then, the packing members (not shown) are fitted into the vertical bar, the curved edge connection fitting, the horizontal bar, and the curved edge connection fitting, to then be fitted into the vertical bar which has been inserted initially. A paired window coupling method is same as that of the conventional assembly method, and has been described above. Accordingly, the detailed description thereof will be omitted. A reference numeral 211a denotes a packing member.

FIG. 11 is a front view of a slider. A paired window 1a moves to the left or right along a guide groove (not shown) such as a rail formed in a window frame 1. The slider includes one window frame and two paired windows. Although only one of edge portions is indicated in dotted lines at one corner in FIG. 11, a portion “C” in each of the four window frame edge connection fittings can be replaced by the curved brace window frame edge connection fitting 105 of FIG. 4 according to an embodiment of the present invention. A portion “CC” can be fabricated into two window frames using eight paired edge connection fittings in two paired windows since the number of paired windows is two (2), and can be replaced by a curved brace paired window connection fitting 105a of FIG. 6 according to an embodiment of the present invention.

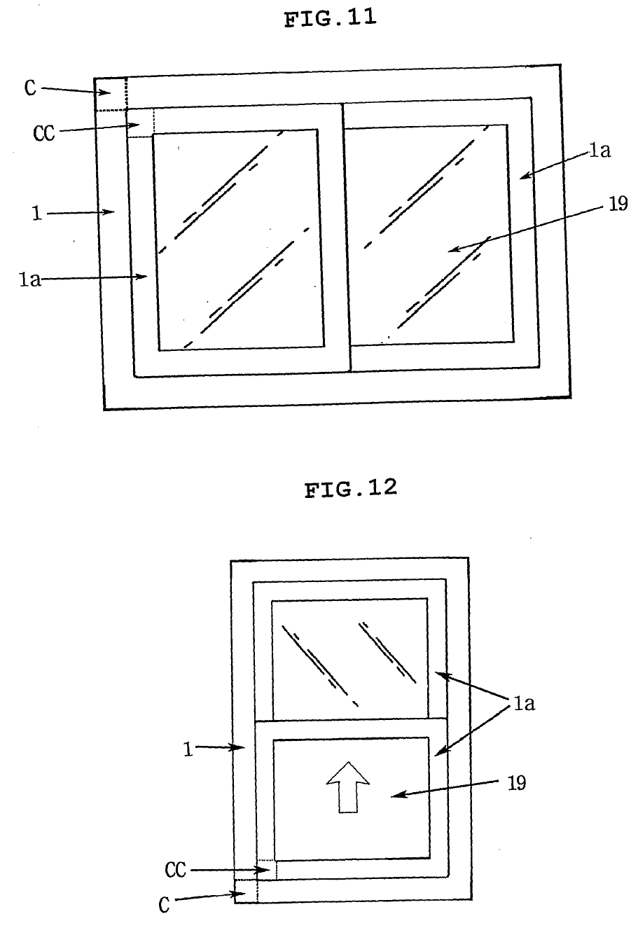

FIG. 12 is a front view of a single-hung. A paired window 1a moves to the left or right along a guide groove (not shown) such as a rail formed in a window frame 1. The slider includes one window frame and two paired windows. Although only one of edge portions is indicated in dotted lines at one corner in FIG. 12, a portion “C” in four window frame edge connection fittings can be replaced by a curved brace window frame structure edge connection fitting 105 according to an embodiment of the present invention. A portion “CC” can be also replaced by a curved brace paired window connection fitting 105a according to an embodiment of the present invention. A reference numeral 19 denotes glass.

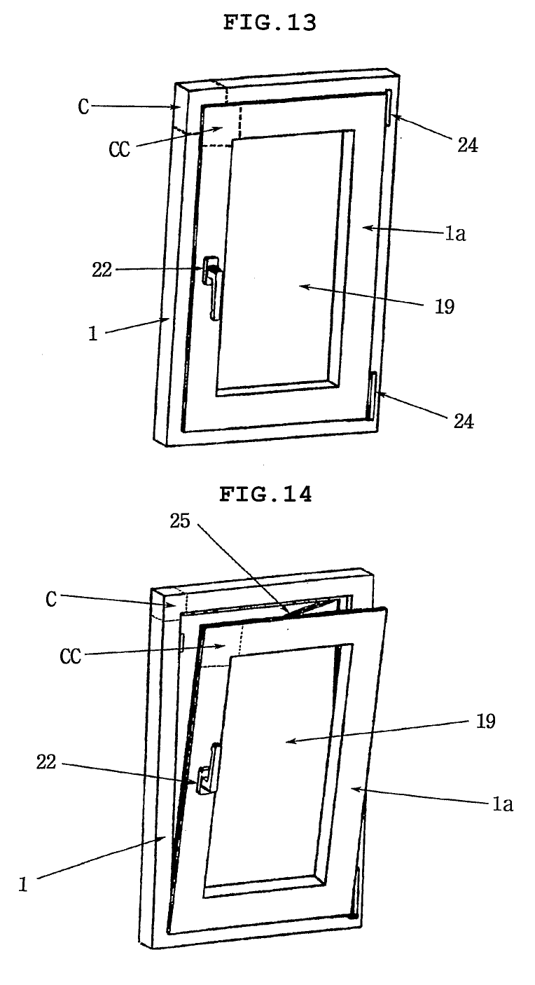

FIG. 13 is a perspective view of a typical casement which is one of casements. Hinges 24 support a paired window 1a and adjusts a knob 22, so that the paired window 1a is opened or closed inwards or outwards. Although a portion “C” is indicated on only one corner, the window frame 1 can be assembled using four curved brace window frame edge connection fittings 205 according to the present invention. A portion “CC” is completed into an edge portion of a paired window using each of four curved brace paired window connection fittings 205a according to an embodiment of the present invention. A reference numeral 19 denotes glass.

FIG. 14 is a perspective view of a tilt which is one of casements. A hinge arm 25 installed in a window frame 1 is coupled with a paired widow 1a. The tilt is a kind of a ventilation window so that the upper portion of the paired window 1a can be opened using a knob 22. Although a portion “C” is indicated on only one corner, the window frame 1 can be assembled using four curved brace window frame edge connection fittings 205 according to the present invention. A portion “CC” is completed into an edge portion of a paired window using each of four curved brace paired window connection fittings 205a according to an embodiment of the present invention. A reference numeral 19 denotes glass.

FIG. 15 is a lateral cross-sectional view of a project which is one of casements. A hinge arm 25 installed in a window frame 1 is coupled with a paired widow 1a. The project is rotated so as to be opened using a knob 22. In the case of the project, the window frame 1 can be assembled using four curved brace window frame edge connection fittings 205 according to the present invention. Also, an edge portion of the paired window can be completed using each of four curved brace paired window edge connection fittings 205a according to the present invention. A reference numeral 19 denotes glass.

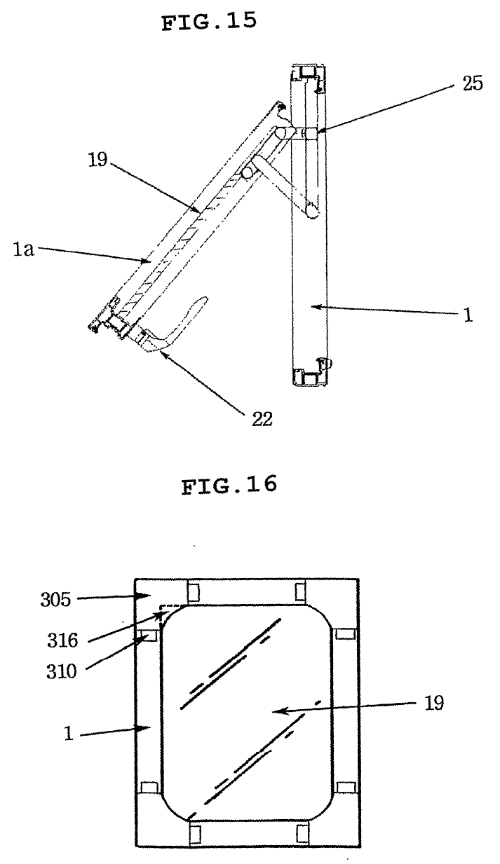

FIG. 16 is a perspective view of a fixed according to another embodiment of the present invention. A paired window is not used in the fix. A glass groove is formed in the window frame 1 so that glass 19 can be directly fitted. Although the glass groove is not shown in the drawing, it is formed at a right angle. The inner circumference of an edge connection fitting 305 excluding the glass groove is of a curved structure forming a brace 316, and the outer circumference thereof is formed at a right angle on a plane and protrusions 310 are formed in both sides of the fix. A reference numeral 19 denotes glass.

### INDUSTRIAL APPLICABILITY

As described above, the present invention provides an aesthetic design effect using a curved brace window frame edge connection fitting and a curved brace paired window edge connection fitting, and other effects of easy cleaning and structural stability with respect to outer objects and persons which may happen to occur at the time of collision with a paired window edge since an edge connection fitting which was formed at a right angle is curved. Also, the present invention provides an effect of enhancing structural reinforcement with respect to an external pressure in coupling a window frame and paired windows, and effects of saving manpower and time and enhancing a productivity per hour in which packing insertion grooves into which packing members such as mohair or wind-proof hair, and gaskets of soft rubber formed in a horizontal bar and a vertical bar of the edge connection fitting are curved to thus have a window frame inserted one time and rotated so as to be fitted with a paired window. Also, the packing members which are inserted without having been cut provide an effect of enhancing functions of a window such as heat insulation, air-tightness, and soundproofing

As described above, the present invention has been described with respect to a particularly preferred embodiment. However, the present invention is not limited to the above embodiment, and it is possible for one who has an ordinary skill in the art to make various modifications and variations, without departing off the spirit of the present invention. Thus, the protective scope of the present invention is not defined within the detailed description thereof but is defined by the claims to be described later and the technical spirit of the present invention.

What is claimed is:

1. A curved brace window frame edge connection fitting for use in a window structure which is installed in an angular opening portion of an architecture building and is formed of a modular window frame, in which the window frame edge connection fitting is positioned at the angular edge of the window frame, characterized in that the window frame edge connection fitting comprises a brace formed in an edge on the inner circumference of the window frame edge connection fitting, wherein the brace is curved, and the outer circumference of the window frame edge connection fitting is angularly formed so as to be congruous with the angular edge of the angular opening portion.

2. A curved brace paired window edge connection fitting for use in a window structure which is installed in an angular opening portion of an architecture building and is formed of a modular set of a window frame and a paired window coupled with the window frame, in which the paired window edge connection fitting is positioned at the edge of the paired window, characterized in that the paired window edge connection fitting is curved so that the outer circumference of the paired window edge connection fitting is congruous with the inner circumference of a curved brace in a window frame edge connection fitting in correspondence to the curved brace window frame edge connection fitting of claim 1, and a curved packing insertion groove is formed on the outer circumference of the paired window edge connection fitting.

3. A window structure which is installed in an angular opening portion of an architecture building, the window structure comprising:
a modular window frame including a curved brace edge connection fitting of claim 1; and
glass which is fitted into the window frame,
wherein the glass is fitted in a glass groove formed in the inner circumference of the window frame including the curved brace window frame edge connection fitting, and the glass groove formed in the inner circumference of the window frame including the curved brace window frame edge connection fitting is angularly formed along an angle formed by the outer circumference of the window frame edge connection fitting.

4. A window structure which is installed in an angular opening portion of an architecture building, the window structure comprising:
a modular window frame including a curved brace edge connection fitting of claim 1; and
a modular paired window which is coupled with the window frame to allow an angular opening portion to be opened and closed, including a curved brace paired window edge connection fitting of claim 2,
wherein a packing insertion groove of the curved paired window edge connection fitting is successively extended and formed on the outer circumference of the paired window.

5. The window structure of claim 4, wherein the window structure is a glass window structure including glass fitted into the paired window,
the inner circumference of the curved brace paired window edge connection fitting in the paired window is formed of a curved plane of the same curvature as that of the outer circumference thereof, and
the glass is fitted in a glass groove formed in the inner circumference of the paired window including the curved brace paired window edge connection fitting, and the glass groove formed in the inner circumference of the paired window including the curved brace paired window edge connection fitting is angularly formed along an angle formed by the outer circumference of the curved brace paired window edge connection fitting.
